(19) United States
(12) Patent Application Publication
(10) Pub. No.: US 2021/0031120 A1
(43) Pub. Date: Feb. 4, 2021

(54) METHOD, SYSTEM AND APPARATUS FOR RACE CIRCUITS

(71) Applicant: DRIVE GO KARTING PTY LTD, Victoria (AU)

(72) Inventor: Christopher David FIELD, Dandenong, Victoria (AU)

(73) Assignee: DRIVE GO KARTING PTY LTD, Victoria (AU)

(21) Appl. No.: 16/968,249

(22) PCT Filed: Feb. 7, 2019
(86) PCT No.: PCT/AU2019/000015

§ 371 Date: Aug. 7, 2020

(30) Foreign Application Priority Data
Feb. 7, 2018 (AU) 2018900375

(51) Int. Cl. A63K 1/00; G07C 9/15; G06F 30/13; G08G 1/09

(52) U.S. Cl. CPC A63K 1/00; G07C 9/15; A63F 13/803; G08G 1/09; G06F 30/13

(57) ABSTRACT

The present invention relates to the field of race circuits and provides a racing circuit layout comprising:
an interconnection between track sections of the racing circuit layout, the interconnection comprising one or a combination of:
at least one crossover;
at least two link sections, and,
at least one barrier or traffic control mechanism operably associated with the crossovers or the at least two link sections,
wherein the at least one barrier or traffic control mechanism is adapted to selectively configure the interconnection so as to provide multiple notional track sections in which combinations thereof form a set of unique racing circuits traversing the track sections and the interconnection.

### RELATED APPLICATIONS

This application claims priority to Australian Provisional Patent Application No. 2018900375 in the name of Drive Go Karting Pty Ltd, which was filed on 7 Feb. 2018, entitled “Method, System and Apparatus for Race Circuits” and the specification thereof is incorporated herein by reference in its entirety and for all purposes.

### FIELD OF INVENTION

The present invention relates to the field of race circuits. It relates to all forms of racing which use custom-designed circuits, whether temporary or permanent, public or professional, whether using wheeled vehicles or not, and whether or not motorized, and electronic or computerized simulations of such racing. It relates particularly, but not exclusively, to professional motorsports, concessional go-karting, mountain bike racing, BMX racing and motocross. It will be convenient to hereinafter describe the invention in relation to go-karting, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

A key problem in concessional go karting in particular, and other forms of racing to a lesser degree, is a lack of circuit variety able to be offered to racers both professional and public. In concessional go karting this creates the problem that there is a lack of customer loyalty, as customers go looking for other circuits to race for the sake of variety, and a lack of interest in coming go karting again.

Existing facilities have tried to combat this problem in three key ways:
A. Running their single circuit in a reverse direction. This is an excellent solution. However, it only increases the circuit count to two.
B. Offering additional full circuits. This is another excellent solution. However, it is resource intensive as it requires both space and capital for each circuit, and only increases the number of circuits on offer by one, or two if they also run in reverse.
C. Having shortcuts which can be opened. This is a less common solution, and not particularly attractive to racers, as it remains essentially the same circuit with a small section cut off, or some other slight variation on what is otherwise an identical experience.

### SUMMARY OF INVENTION

An object of the present invention is to provide a race circuit which is reconfigurable in order to alter the number of available racing circuits.

A further object of the present invention is to provide a race circuit which is reconfigurable in order to provide a plurality of available racing circuits.

A further object of the present invention is to alleviate at least one disadvantage associated with the related art.

In a first aspect of embodiments described herein there is provided a racing circuit layout comprising:
an interconnection between track sections of the racing circuit layout, the interconnection comprising one or a combination of:
at least one crossover;
at least two link sections, and,
at least one barrier or traffic control mechanism operably associated with the crossovers or the at least two link sections,
wherein the at least one barrier or traffic control mechanism is adapted to selectively configure the interconnection so as to provide multiple notional track sections in which combinations thereof form a set of unique racing circuits traversing the track sections and the interconnection.

The set of unique racing circuits traversing the track sections and the interconnection may be adapted to allow racing in either clockwise or anticlockwise directions. Furthermore, the set of unique racing circuits may provide for separate racing events to be held simultaneously at the one racing venue accommodating the racing circuit layout.

Preferably, each link section is proximate to and/or associated with a crossover and the at least one crossover may comprise one or a combination of a bridge and an underpass.

In preferred embodiments, no two unique circuits of the formed set of unique racing circuits bear more than 50% similarity to each other. In preferred embodiments, between at least two and up to at least sixty unique racing circuits are configurable with the multiple notional track sections and the interconnection. Between one and four unique racing circuits may be operated for racing, simultaneously in accordance with preferred embodiments.

Preferably, at least one pit and/or administrative area is integrated into one or each track section.

In another aspect of embodiments described herein there is provided a method of forming one or a plurality of unique racing circuits from a racing circuit layout, the method comprising the steps of:
interconnecting track sections of the racing circuit layout with one or a combination of:
at least one crossover;
at least two link sections, and,
at least one barrier or traffic control mechanism operably associated with the crossovers or the at least two link sections,
selectively configuring the interconnection by adapting the at least one barrier or traffic control mechanism to provide multiple notional track sections in which combinations thereof form a set of unique racing circuits traversing the at least two track sections and the interconnection.

In a further aspect of embodiments described herein there is provided a method of configuring a race track to form one or a plurality of unique racing circuits of the race track, the method comprising the steps of:
using one or a combination of;
at least one crossover,
at least two link sections, and,
at least one barrier or traffic control mechanism operably associated with the crossovers or the at least two link sections,
to selectively configure multiple notional track sections in which combinations thereof form a set of unique racing circuits traversing either:
one or a combination of sections of the race track; or,
all sections of the race track.

In preferred embodiments of the methods disclosed herein, the at least two link sections may be associated with each crossover and, the at least one crossover may comprise one or a combination of a bridge and an underpass. Furthermore, between at least two and up to at least twelve unique circuits may be configurable with the race track according to preferred embodiments of methods disclosed herein and, between at least two and up to at least sixty unique racing circuits may be configurable with the multiple notional track sections and the interconnection. According to preferred methods between one and four unique racing circuits may be operated for racing, simultaneously.

In yet another aspect of preferred embodiments described herein there is provided a system for configuring a race track, said system comprising a computer usable medium having computer readable program code and computer readable system code embodied on said medium for forming one or a plurality of unique racing circuits within a data processing system, said computer program product comprising computer readable code within said computer usable medium for:
interconnecting track sections of the race track with one or a combination of:
at least one crossover;
at least two link sections, and,
at least one barrier or traffic control mechanism operably associated with the crossovers or the at least two link sections,
selectively configuring the interconnection by adapting the at least one barrier or traffic control mechanism so as to provide multiple notional track sections in which combinations thereof form a set of unique racing circuits traversing the track sections and the interconnection.

Preferred forms of the present invention include apparatus adapted to configure a race track, said apparatus comprising:
processor means adapted to operate in accordance with a predetermined instruction set,
said apparatus, in conjunction with said instruction set, being adapted to perform the method steps as disclosed herein.

Other preferred forms of the present invention include a computer program product comprising:
a computer usable medium having computer readable program code and computer readable system code embodied on said medium for forming one or a plurality of unique racing circuits within a data processing system, said computer program product comprising:
computer readable code within said computer usable medium for performing the method steps as disclosed herein.

Other aspects and preferred forms are disclosed in the specification and/or defined in the appended claims, forming a part of the description of the invention.

In essence, embodiments of the present invention stem from the realization that using a combination of four or more track sections which meet at either end at two or more bridges, in concert with linking roads at each bridge that allow access from any track section to any other track section without blocking the use of the remaining sections, creates a reconfigurable racing circuit layout with a greater number of variations, and a greater degree of variation between each layout, than existing racing track designs.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a schematic plan view which illustrates multiple alternative configurations of racing circuits according to an embodiment of the present invention;

FIG. 1A is a schematic plan view which illustrates, on a larger scale, one of the multiple alternative configurations of racing circuits according to the embodiment of FIG. 1; and

FIGS. 2 to 11 are geographically-realistic plan views which illustrate multiple alternative configurations of racing circuits according to an embodiment of the present invention;

FIG. 12 is a schematic plan view of a racing circuit layout adaptable for being configured to provide a set of unique racing circuits in accordance with a preferred embodiment of the invention.

### DETAILED DESCRIPTION

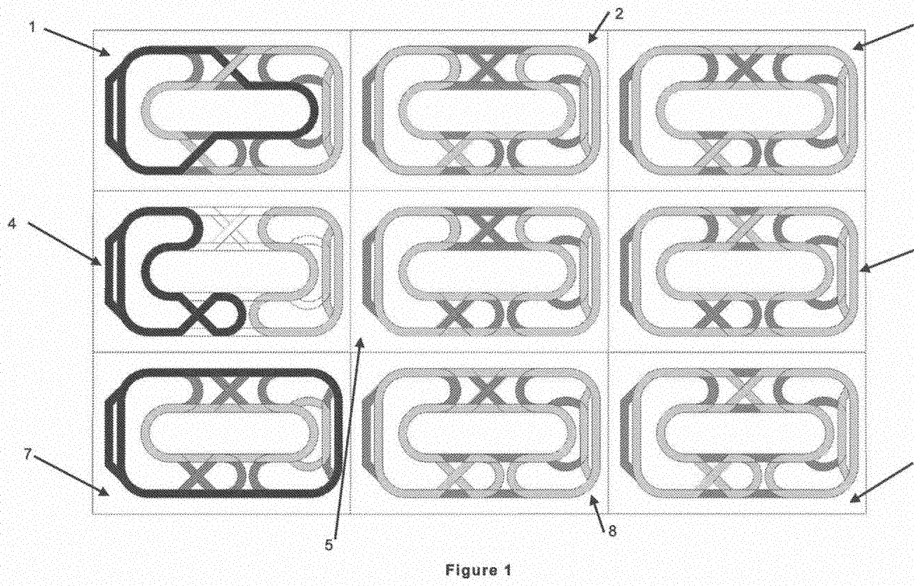

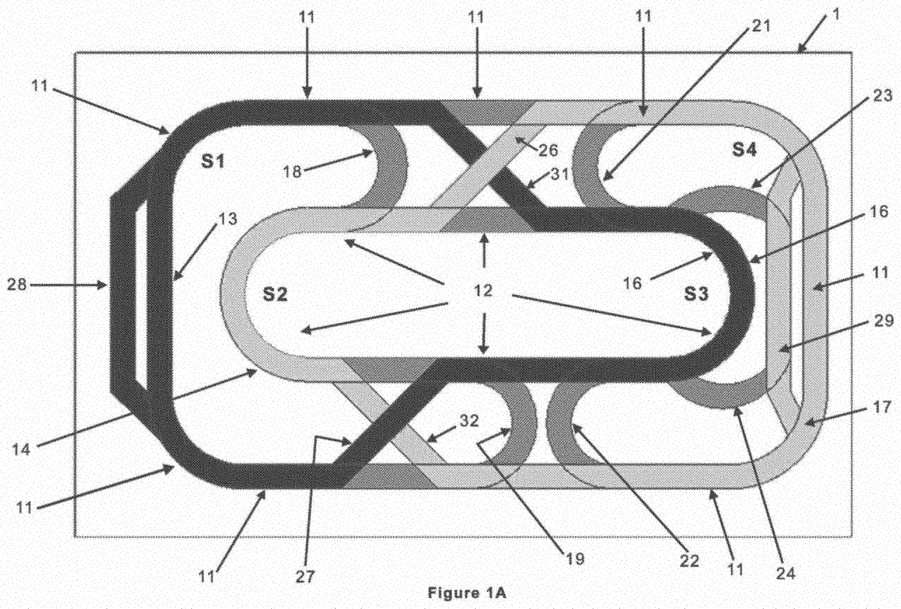

FIG. 1 is a schematic plan view which illustrates a set of alternative unique circuits formed within circuit layout combinations 1 to 9 of a racing track or racing circuit complex which can be achieved according to one embodiment of the present invention. FIG. 1A is a schematic plan view, on a larger scale, of the alternative circuit layout combination 1 of FIG. 1. The embodiments of the invention which are illustrated in FIGS. 1 and 1A are schematic representations for the purposes of explaining the principles of the invention, particularly preferred forms of the invention may not use such simple geometric forms.

FIGS. 1 and 1A illustrate a racing circuit layout which has:
tracks 11 and 12, each of which comprise track sections S1, S4 and S2, S3, respectively;
link sections 18, 19, 21, 22, 23 and 24;
bridges 26 and 27;
pits/administrative areas 28 and 29; and
“underpass” areas 31 and 32 beneath the bridges 26 and 27, respectively.

The track 11 is substantially in the shape of the periphery of a rounded rectangle while the track 12 is substantially concentric with the track 11 and is substantially in the shape of the periphery of an arena or a stadium (in the mathematical sense of that term). Generally speaking, track 11 is an outer track and track 12 is an inner track.

The link sections 18, 19, 21, 22, 23 and 24; the bridges 26 and 27; and the “underpass” areas 31 and 32 interconnect the outer track 11 and the inner track 12.

Multiple configurations of the racing tracks are achieved by treating each of the outer track 11 and the inner track 12 as comprising multiple notional sections, eg S1, S2, S3 and S4, various combinations of which (together with link sections, bridge sections and underpasses) form different racing circuits. The number of racing circuits thus formed is potentially doubled by allowing racing in both clockwise and anti-clockwise directions.

The specific embodiment of FIG. 1A illustrates four possible configurations of racing circuit, which allow for simultaneous racing on all, or any combination of, those circuits. Two of those configurations are formed by allowing racing in both clockwise and anti-clockwise directions around the following combination of track sections, bridges, underpasses and link sections (which are represented in solid black colour in FIG. 1A):
the section 13 of the outer track 11, ie S3
the bridge 27 from the outer track 11 to the inner track 12;
the section 16 of the inner track 12, ie S3; and
the underpass 31 from the inner track 12 to the outer track 11.

Similarly, two of the configurations of racing circuit are formed by allowing racing in both directions around the following combination of track sections, even when racing is taking place on either, or both, of the two previously-described racing circuits:
the section 14 of the inner track 12, ie S2
the underpass 32 from the inner track 12 to the outer track 11;
the section 17 of the outer track 11, ie S4; and
the bridge 26 from the outer track 11 to the inner track 12.

The provision of a plurality of circuits simultaneously is not essential, but is available on most of the versions discussed herein. For example, in one embodiment, a track configuration provides a 12-track single-pit version of a racing circuit without having multiple simultaneous tracks available.

Returning to FIG. 1, a total of 24 unique racing circuits may be formed by the paths available in circuit layout combinations 1 to 9 as follows. In the following, the individual circuits are indicated with track progression sequences. Text showing both the sequence of track sections or segments, S1, S2, S3, S4, and direction of travel within the respective segments, listed as ‘f’ (forward) and ‘r’ (reverse), where ‘forward’ is the clockwise direction of travel as seen in the ‘interlinked’ track/circuit layout as set up.

Circuit layout combination 1 of FIG. 1 has four unique circuits with track progression sequences of: (S1f, S3f); (S1r, S3r), (S4f, S2f), (S4r, S2r).

Circuit layout combination 2 of FIG. 1 has two unique circuits with track progression sequences of: (S4f, S2f, S1r, S3r), (S4r, S3f, S1f, S2r).

Circuit layout combination 3 of FIG. 1 has two unique circuits with track progression sequences of: (S4f, S2f, S3f, S1f), (S4r, S1r, S3r, S2r).

Circuit layout combination 4 of FIG. 1 has four unique circuits with track progression sequences of: (S1f, S2r), (S1r, S2f), (S4f, S3r), (S4r, S3f).

Circuit layout combination 5 of FIG. 1 has two unique circuits with track progression sequences of: (S4f, S1f, S2r, S3r), (S4r, S3f, S2f, S1r).

Circuit layout combination 6 of FIG. 1 has two unique circuits with track progression sequences of: (S4f, S1f, S3f, S2f), (S4r, S2r, S3r, S1r).

Circuit layout combination 7 of FIG. 1 has four unique circuits with track progression sequences of: (S1f, S4f), (S1r, S4r), (S3f, S2f), (S3r, S2r).

Circuit layout combination 8 of FIG. 1 has two unique circuits with track progression sequences of: (S4f, S3r, S2r, S1f), (S4r, S1r, S2f, S3f).

Circuit layout combination 9 of FIG. 1 has two unique circuits with track progression sequences of: (S4f, S3r, S1r, S2f), (S4r, S2r, S1f, S3f).

To re-configure the available racing circuits, movable barriers or other forms of traffic control are used to direct racers to proceed from one track, or track section to another, whether via a bridge or by under-passing a bridge. Traffic control methods may include but are not limited to: Impact absorbing (crash) barriers which may be moved to block travel in all directions other than the direction desired; Line markings or directional signage to indicate the correct direction of progress; Digital signage or other electronic means of communicating the correct direction of progress; any other method or combination of methods that may serve the purpose of the specific racing event in question, according to their requirements for safety, spectator amenity, access, or any other requirement.

As illustrated, the circuit layout combination 7 of FIG. 1 similarly provides potentially four racing circuits, two of which utilize the outer track 11 and two of which utilize the inner track 12.

The circuit layout combination 4 of FIG. 1 again provides potentially four racing circuits, but each of which utilizes at least a part of the outer track 11 and at least a part of the inner track 12. In this particular embodiment, separate ends of the circuit layout combination 4 of FIG. 1 can be used for racing to take place simultaneously for separate racing events. Furthermore, the integration of the two pits/administrative areas 28 and 29 into the outer track 11 allows simultaneous racing on the circuits which are represented on the opposite halves of FIG. 1A.

The circuit layout combinations 2, 3, 5, 6, 8 and 9 of FIG. 1 each provides potentially two racing circuits, each of those two circuits being provided by racing in different directions around a configuration on substantially all of both the outer track 11 and the inner track 12.

As will be seen from the above description, even if racing is limited to one direction on each combination of links, bridges and track sections, the presently-described embodiment, without limitation to the scope of other embodiments of the present invention, allows for the provision of twelve different configurations of racing circuit, with no two of these tracks bearing more than a 50% similarity to each other when the direction of travel is taken into account. This number of configurations is doubled when racing is enabled in both directions. This allows a concessional karting venue, BMX track venue, professional racing venue, or other facility to offer wide track variety, and even the option of offering ‘championships’ where racers return to the same venue to race different tracks over time for a single-location multi-track championship with 12 or more rounds.

Larger scale variations on this method allow 24, 36, and over 60 tracks respectively, with between 1 and 4 tracks able to be operated simultaneously.

At a minimum this circuit design method involves two bridges, each with at least two associated links, and four track sections which travel between both bridges. Movable barriers or other forms of traffic control are used to direct racers to proceed from one track section to another, whether via the bridge or bypassing the bridge, and without stopping the possible use of the remaining sections. That is, there is still a way to proceed between the two remaining sections that intersect near that bridge without intersecting with the link sections in use.

The bridges and associated link sections allow racers to proceed from any track section to any other track section without blocking the use of the remaining sections. This can be done with as few as two link sections, however most applications will use three or sometimes four link sections. The specific number of link sections is irrelevant, what is relevant is that it facilitates the above functionality.

Again, with reference by example to FIGS. 1 and 1A, complete tracks may use two sections or four sections of track sections S1, S2, S3 and S4 to make up the specific layout. These may be expressed as full-length (4 sections) or half-length (2 sections) tracks. When additional pit or administration areas are included, it is possible for two half-length circuits to operate simultaneously.

The basic variations on this method are as follows:
A. A two-bridge, four-section, variant with one pit/administrative area which allows 12 unique variations, all of which use all four sections of track, and all of which are at least 50% unique from any other individual variation.
B. A two-bridge, four-section, variant with two pit/administrative areas, which allows 12 unique full-length variations, and a further 12 unique half-length variations. Each variation is at least 50% unique from any other variation of the same length.
C. A four-bridge, eight-section, variant with two or four pit/administrative areas, allowing tracks from full length down to quarter length, and between 1 and 4 tracks to operate simultaneously.

A further variation on the above base principles is to add additional linking sections which are not in proximity with any bridges. This facilitates additional variations and increases the uniqueness of each variation.

According to another embodiment of the present invention, allowing for racing in one or two directions of a racing circuit, the total number of possible unique racing circuits “T” may be given by the following relationship, without limitation to other embodiments of the invention:

T=Bₓ(V+P)

### Where

B=number of bridges,
V=section variants, and
P=number of pit/administration areas.

### Alternately,

T=(BₓVₓL)/2

### Where

B=number of bridges
V=number of track sections
L=number of link sections
   Note; B can also be ‘crossovers’ where a crossover is either a bridge or underpass, or a combination of both

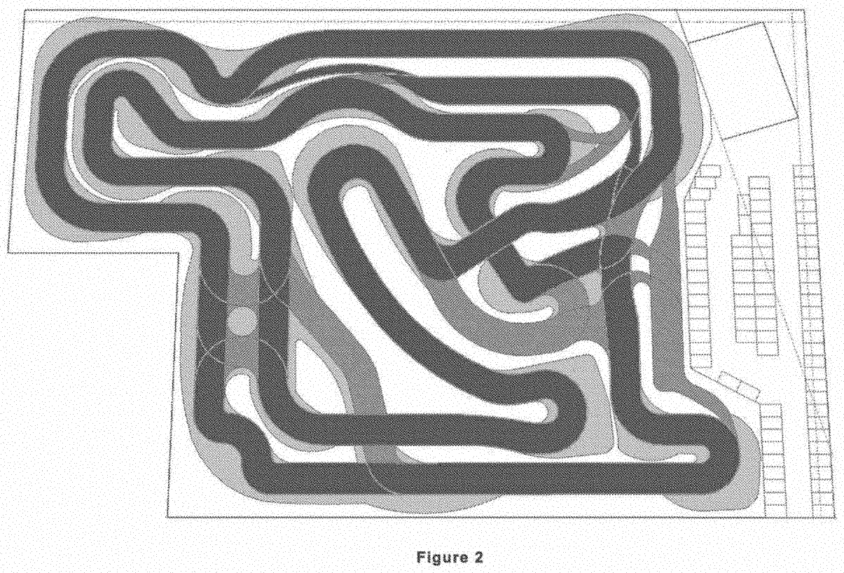

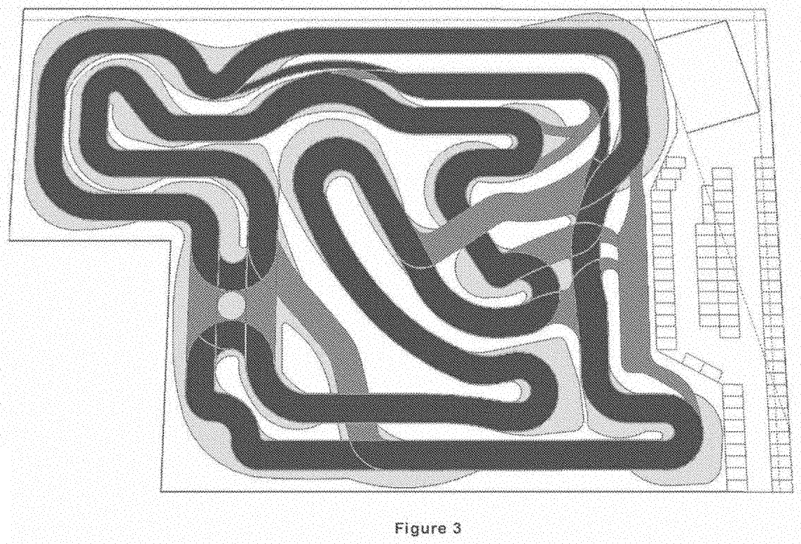

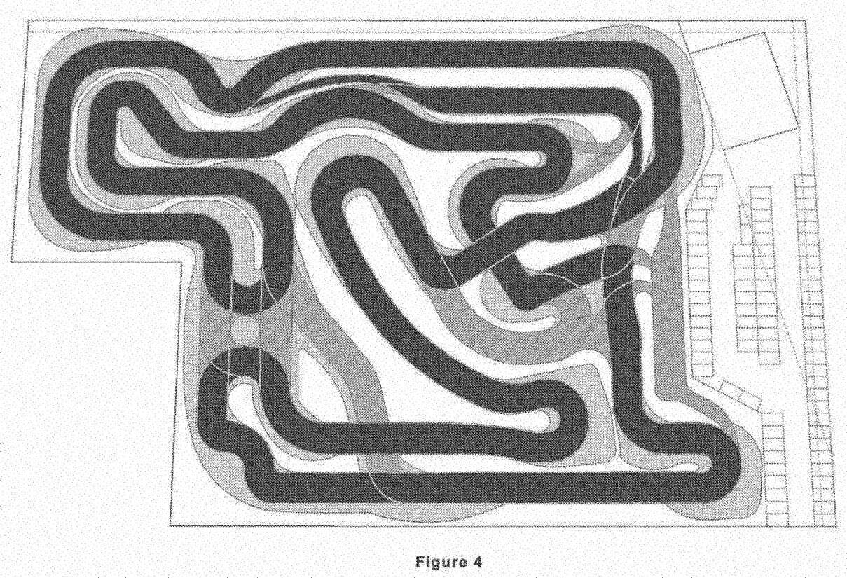

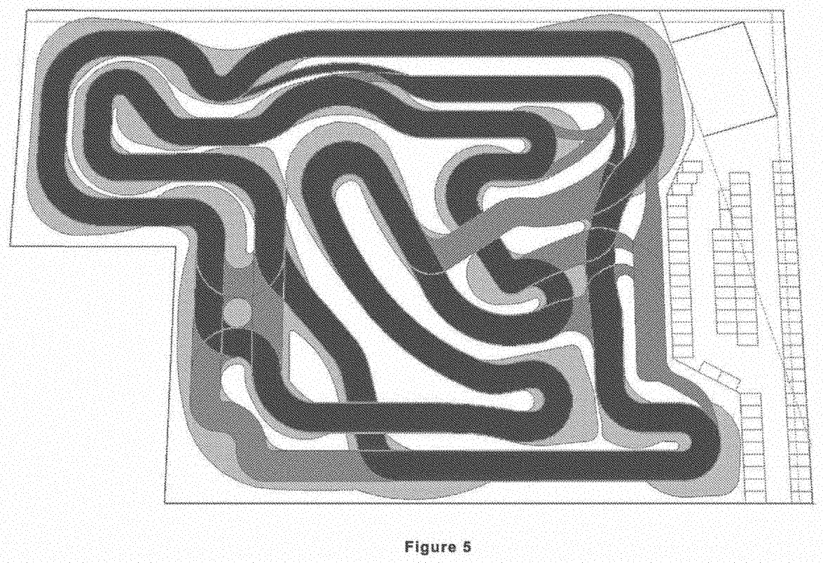

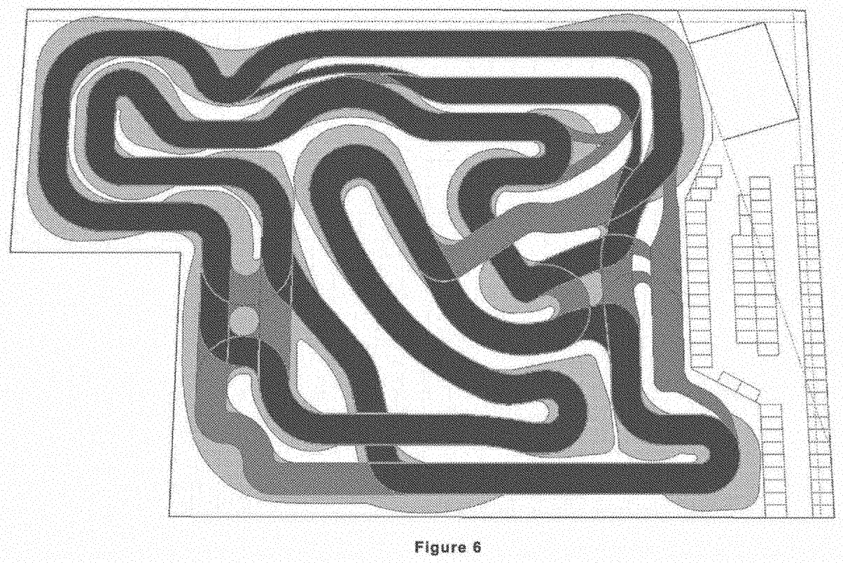

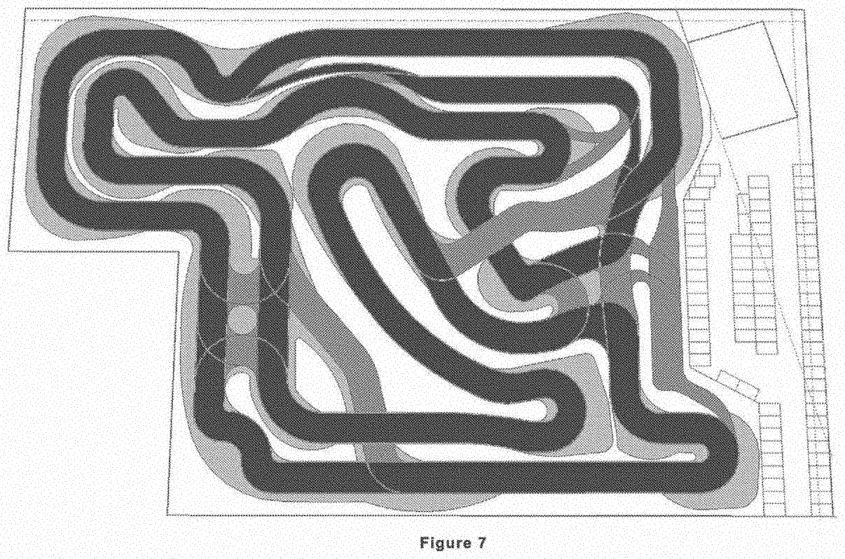

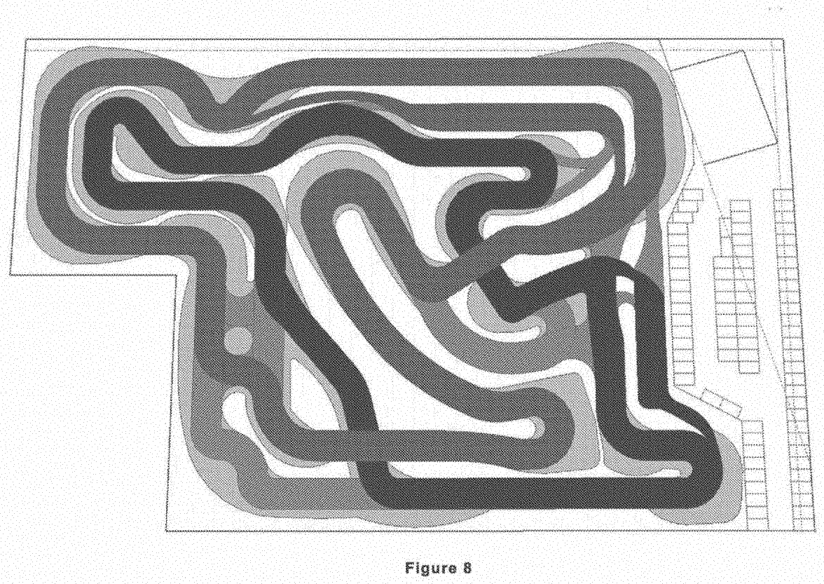

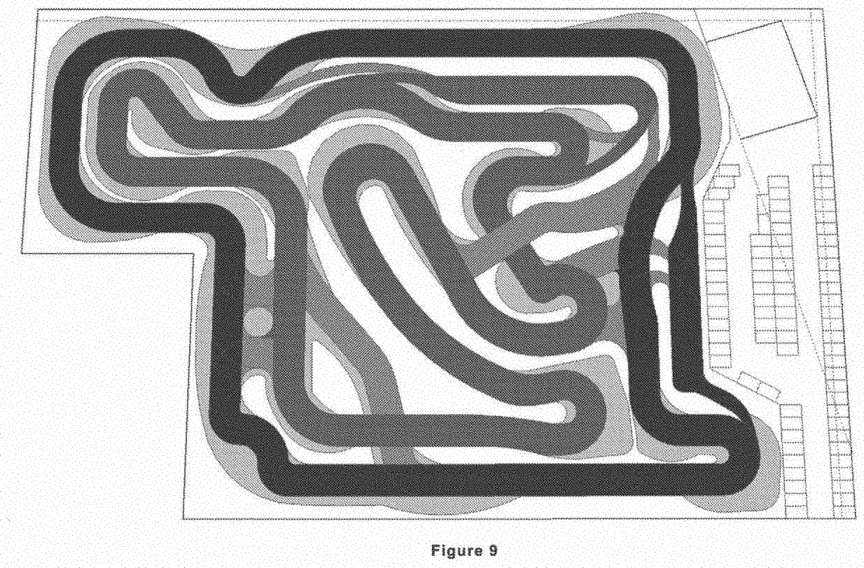

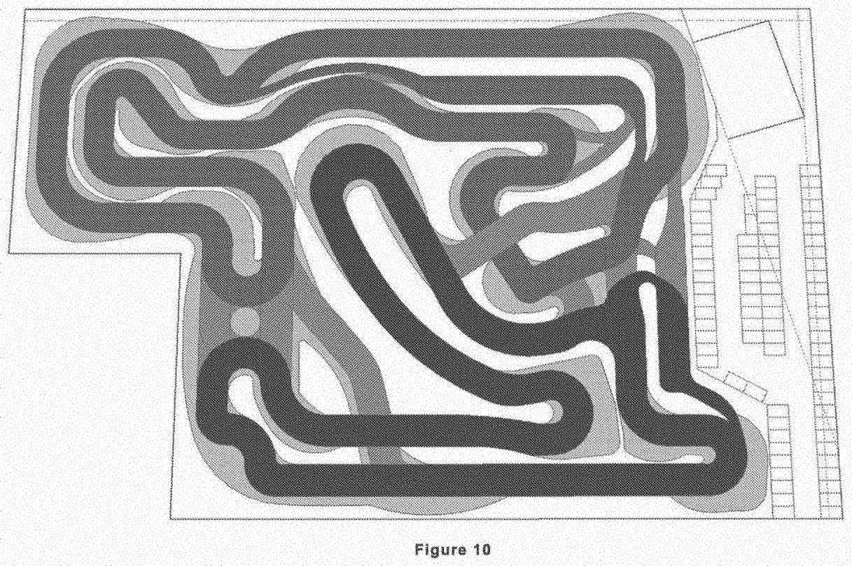

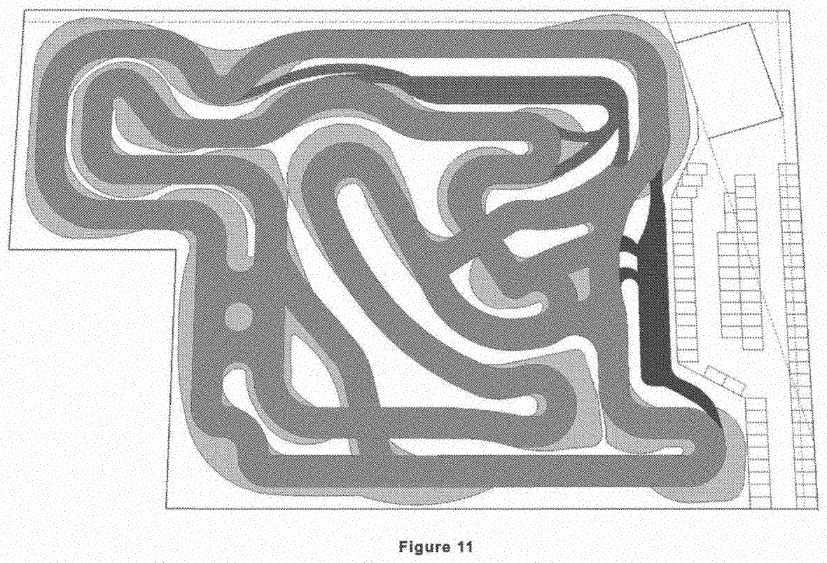

FIGS. 2 to 11 are plan views which illustrate practical real-world layouts according to an embodiment of the present invention. As is described above in conjunction with FIGS. 1 and 1A, FIGS. 2 to 11 illustrate circuit layout combinations which are configured by choosing sections of tracks, bridges, overpasses, underpasses, link sections and pit/administrative areas. The embodiment of these figures uses four track sections which meet at a combination of bridges and link roads (3 link roads per bridge have been used). Although the number of link roads is not relevant, it is only required that the link roads combined with the bridges facilitate progress from any section of track to any other section of track without blocking the use of the remaining sections. Because there are two pit areas, tracks of both full-length and half-length can be in use, with two half-length tracks being able to be in use simultaneously. In these figures:
FIGS. 2 to 7 each shows a single-track configuration (illustrated in solid white colour) which potentially provides two circuit configurations;
FIGS. 8 to 10 each shows two track configurations (one illustrated in solid white and one illustrated in dark-grey) which potentially provides four circuit configurations; and
FIG. 11 shows a single-track configuration (illustrated in mid-grey) which potentially provides two circuit configurations.

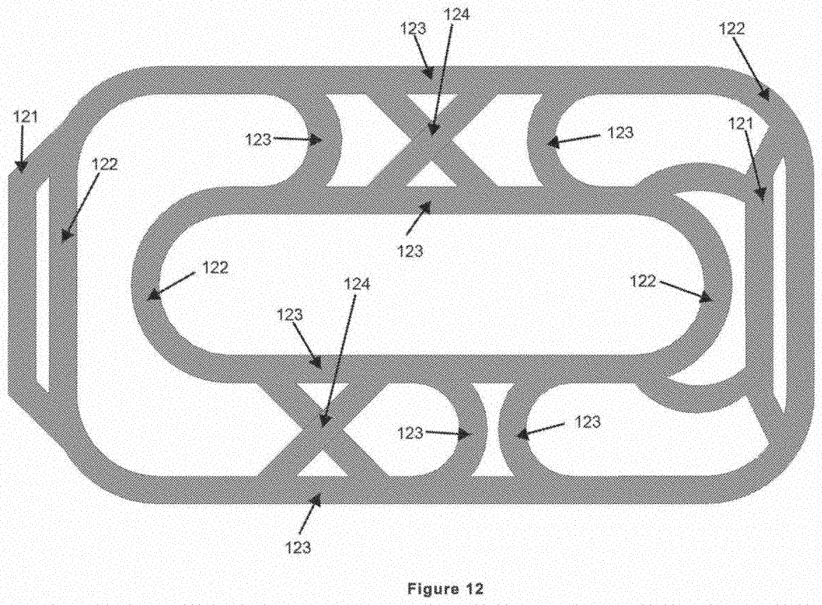

FIG. 12 shows a schematic plan view of a racing circuit layout adaptable for being configured to provide a set of unique racing circuits in accordance with a preferred embodiment of the invention. Pit areas 121 are included with track sections 122. The number of links 123 is not crucial so long as race participants can proceed from any track section 122 to any other track section 122 of the circuit layout. Two variations of using four links 123 near each bridge 124 is shown. Further variants are possible with only two or three links 123

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically, a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML, Icon; Java; Javascript; Lisp; Logo; Mathematica; MatLab; Miranda; Modula-2; Oberon; Pascal; Perl; PL/I, Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1-23. (canceled)

24. A racing circuit layout comprising:
an interconnection between track sections of the racing circuit layout, the interconnection comprising one or a combination of:
at least one crossover;
at least two link sections, and,
at least one barrier or traffic control mechanism operably associated with the crossovers or the at least two link sections,
wherein the at least one barrier or traffic control mechanism is adapted to selectively configure the interconnection so as to provide multiple notional track sections in which combinations thereof form a set of unique racing circuits traversing the track sections and the interconnection.

25. A racing circuit layout as claimed in claim 24 wherein the set of unique racing circuits traversing the track sections and the interconnection are adapted to allow racing in either clockwise or anticlockwise directions.

26. A racing circuit layout as claimed in claim 24 wherein the set of unique racing circuits provides for separate racing events to be held simultaneously at the one racing venue accommodating the racing circuit layout.

27. A racing circuit layout as claimed in claim 24 wherein each link section is proximate to and/or associated with a crossover.

28. A racing circuit layout as claimed in claim 24 wherein the at least one crossover comprises one or a combination of a bridge and an underpass.

29. A racing circuit layout as claimed in claim 24 wherein no two unique circuits of the formed set of unique racing circuits bear more than 50% similarity to each other.

30. A racing circuit layout as claimed in claim 24 wherein between at least two and up to at least sixty unique racing circuits are configurable with the multiple notional track sections and the interconnection.

31. A racing circuit layout as claimed in claim 30 wherein between one and four unique racing circuits are operated for racing, simultaneously.

32. A racing circuit layout as claimed in claim 24 wherein at least one pit and/or administrative area is integrated into one or each track section.

33. A method of configuring a race track to form one or a plurality of unique racing circuits of the race track, the method comprising the steps of:
using one or a combination of;
at least one crossover,
at least two link sections, and,
at least one barrier or traffic control mechanism operably associated with the crossovers or the at least two link sections,
to selectively configure multiple notional track sections in which combinations thereof form a set of unique racing circuits traversing either:
one or a combination of sections of the race track; or,
all sections of the race track.

34. A method as claimed in claim 33 wherein the at least two link sections are associated with each crossover.

35. A method as claimed in claim 33 wherein the at least one crossover comprises one or a combination of a bridge and an underpass.

36. A method as claimed in claim 33 wherein between at least two and up to at least twelve unique circuits are configurable with the race track.

37. A method as claimed in claim 33 wherein no two unique circuits bear more than 50% similarity to each other.

38. A method as claimed in claim 33 wherein between at least two and up to at least sixty unique racing circuits are configurable with the multiple notional track sections and the interconnection.

39. A method as claimed in claim 38 wherein between one and four unique racing circuits are operated for racing, simultaneously.

40. A method as claimed in claim 33 wherein at least one pit and/or administrative area is integrated into one or each section of the race track.

41. A system for configuring a race track, said system comprising a computer usable medium having computer readable program code and computer readable system code embodied on said medium for forming one or a plurality of unique racing circuits within a data processing system, said computer program product comprising computer readable code within said computer usable medium for:
interconnecting track sections of the race track with one or a combination of:
at least one crossover;
at least two link sections, and,
at least one barrier or traffic control mechanism operably associated with the crossovers or the at least two link sections,
selectively configuring the interconnection by adapting the at least one barrier or traffic control mechanism so as to provide multiple notional track sections in which combinations thereof form a set of unique racing circuits traversing the track sections and the interconnection.

42. Apparatus adapted to configure a race track, said apparatus comprising:
processor means adapted to operate in accordance with a predetermined instruction set,
said apparatus, in conjunction with said instruction set, being adapted to perform the method steps as claimed in claim 33.

43. A computer program product comprising:
a computer usable medium having computer readable program code and computer readable system code embodied on said medium for forming one or a plurality of unique racing circuits within a data processing system, said computer program product comprising:
computer readable code within said computer usable medium for performing the method steps as claimed in claim 33.
